(19) United States
(12) Patent Application Publication
(10) Pub. No.: US 2013/0260658 A1
(43) Pub. Date: Oct. 3, 2013

(54) Shell cracking device

(71) Applicants: Mary E. Brooks, Morgan City, LA (US); Therol R. Naquin, Morgan City, LA (US)

(72) Inventors: Mary E. Brooks, Morgan City, LA (US); Therol R. Naquin, Morgan City, LA (US)

(21) Appl. No.: 13/851,054

(22) Filed: Mar. 26, 2013

Related U.S. Application Data
(60) Provisional application No. 61/618,374, filed on Mar. 30, 2012.

(51) Int. Cl. A22C 29/02

(52) U.S. Cl. CPC A22C 29/027
USPC 452/6

(57) ABSTRACT

A shell cracking device that includes a top scissor portion having a first eye ring, a first aperture, a first semi-circular cracking indenture and a first blade portion and a bottom scissor portion coupled to the top scissor portion, the bottom scissor portion having a second eye ring, a second aperture, a second semi-circular cracking indenture and a second blade portion. The device also includes a rivet inserted into the first aperture and the second aperture, the rivet allows the top scissor portion and the bottom scissor portion to open and to receive a piece of shelled food and to close down on the piece of shelled food and an eye ring covering placed on the first eye ring and the second eye ring to provide an ergonomic grip on the shell cracking device.

This application claims priority to U.S. Provisional Application 61/618,374 filed on Mar. 30, 2012, the entire disclosure of which is incorporated by reference.

### BACKGROUND OF THE INVENTION

1. Field of the Invention

The present invention is a cracking device. More specifically, the present invention is a shell cracking device.

2. Description of the Related Art

Traditional crab and lobster shell crackers and hammers can be hard to utilize and hard to position comfortably and safely in a user's hands, especially if the user's hands are wet. Also, smashing a shell of a piece of crab or a piece of lobster can ruin any meat inside the piece of crab or the piece of lobster and spoil eating the piece of crab or the piece of lobster.

The present invention allows a user to crack a shell of a shelled piece of seafood such as a piece of crab, a piece of lobster or other suitable shelled food without damaging meat contained within the shell.

### BRIEF SUMMARY OF THE INVENTION

The present invention is a cracking device. More specifically, the present invention is a shell cracking device.

The shell cracking device includes a top scissor portion having a first eye ring, a first aperture, a first semi-circular cracking indenture and a first blade portion and a bottom scissor portion coupled to the top scissor portion, the bottom scissor portion having a second eye ring, a second aperture, a second semi-circular cracking indenture and a second blade portion. The device also includes a rivet inserted into the first aperture and the second aperture, the rivet allows the top scissor portion and the bottom scissor portion to open and to receive a piece of shelled food and to close down on the piece of shelled food and an eye ring covering placed on the first eye ring and the second eye ring to provide an ergonomic grip on the shell cracking device

It is an object of the present invention to provide a shell cracking device that prevents a user from having to utilize a hammer or a traditional crab cracker to break a shell of a piece of shelled food, which can be a difficult and time consuming process, but can cause the shell to become crushed into meat held within the shell.

It is an object of the present invention to provide a shell cracking device with an ergonomic eye ring covering that provide comfortable and more ergonomic control, which helps to reduce any hand slippage during use.

It is an object of the present invention to provide a shell cracking device that serves as a multifunction tool that can be used on any size and type of food with a shell such as a piece of crab, a piece of lobster or other piece of shell food.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an overhead view of a shell cracking device, in accordance with one embodiment of the present invention.

FIG. 2 illustrates an overhead view of a top scissor portion, in accordance with one embodiment of the present invention.

FIG. 3 illustrates an overhead view of a bottom scissor portion, in accordance with one embodiment of the present invention.

FIG. 4 illustrates a front view of a rivet, in accordance with one embodiment of the present invention.

FIG. 5 illustrates an overhead view of an eye ring covering, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

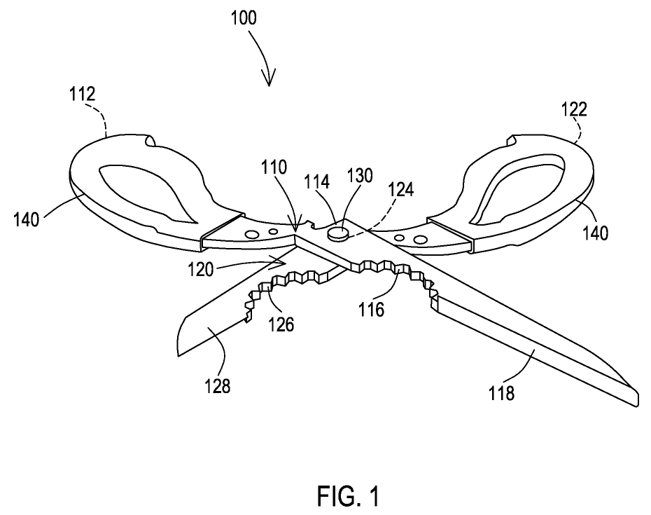

FIG. 1 illustrates an overhead view of a shell cracking device 100, in accordance with one embodiment of the present invention.

The shell cracking device 100 includes a top scissor portion 110, a bottom scissor portion 120, a rivet 130 and an eye ring covering 140. The top scissor portion 110 can have a first eye ring 112, a first aperture 114, a first semi-circular cracking indenture 116 and a first blade portion 118. The first semi-circular cracking indenture 116 can be serrated to better grasp any shelled food being cracked than a non-serrated semi-circular cracking indenture (not shown). The top scissor portion 110 can be made of stainless steel or any other suitable material. The scissor portion bottom 120 can be coupled to the top scissor portion 110. The scissor portion bottom 120 can have a second eye ring 122, a second aperture 124, a second semi-circular cracking indenture 126 and a second blade portion 128. The second semi-circular cracking indenture 126 can be serrated to better grasp any shelled food being cracked than a non-serrated semi-circular cracking indenture (not shown). The bottom scissor portion 120 can be made of stainless steel or any other suitable material. The top scissor portion 110 can be relatively longer than the bottom scissor portion 120 to facilitate a user to cut relatively large crab legs such as Alaskan king crab legs, a lobster tail or other relatively large shell food.

The rivet 130 can be inserted into the first aperture 114 and the second aperture 124. The rivet 130 can allow the top scissor portion 110 and the bottom scissor portion 120 to open and to receive a piece of shelled food (not shown) such as a piece of seafood, a piece of crab, a piece of lobster or other suitable piece of shelled food. The rivet 130 can allow the top scissor portion 110 and the bottom scissor portion 120 to close down on a piece of shelled food such as a piece of crab, a piece of lobster or other suitable piece of shelled food and exert pressure on the piece of shelled food and crack the piece of shelled food. The rivet 130 can be made of stainless steel or other suitable material. The first semi-circular cracking indenture 116 and the can be disposed adjacent to the rivet 130 on the top scissor portion 110 and the bottom scissor portion 120 to apply force to the piece of shelled food such as a piece of crab, a piece of lobster or other suitable piece of shelled food. The eye ring covering 140 can be placed on the first eye ring 112 and the second eye ring 122 to provide an ergonomic grip on the shell cracking device 100. The eye ring covering 140 can be made of thermoplastic rubber or TPR, thermoplastic elastomer or TPE or other suitable material.

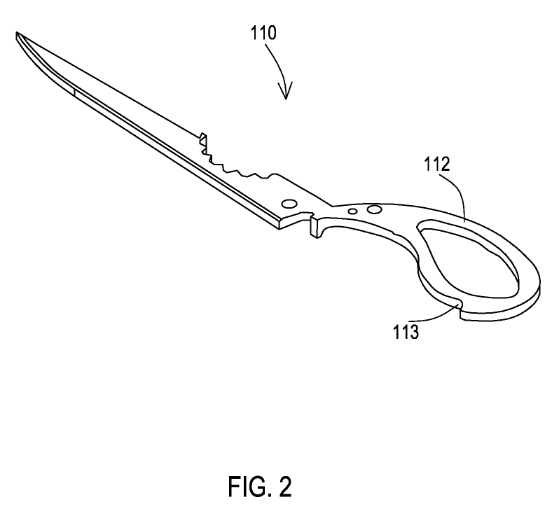

FIG. 2 illustrates an overhead view of a top scissor portion 110, in accordance with one embodiment of the present invention. The top scissor portion 110 illustrated in FIG. 2 does not illustrate the eye ring covering 140 disposed on the first eye ring 112. The first eye ring 112 can have a similar ergonomic shape as the eye ring covering 140 to accommodate the eye ring covering 140. The first eye ring 112 can include a first notch 113 to ergonomically accommodate a user's fingers (not shown).

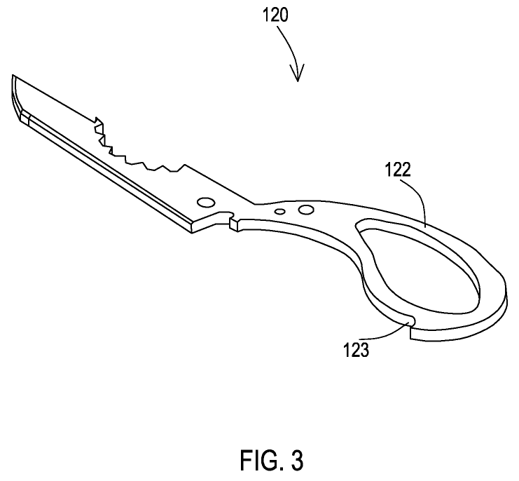

FIG. 3 illustrates an overhead view of a bottom scissor portion 120, in accordance with one embodiment of the present invention. The bottom scissor portion 120 illustrated in FIG. 3 does not illustrate the eye ring covering 140 disposed on the second eye ring 122. The second eye ring 122 can have a similar ergonomic shape as the eye ring covering 140 to accommodate the eye ring covering 140. The second eye ring 122 can include a second notch 123 to accommodate a user's fingers (not shown).

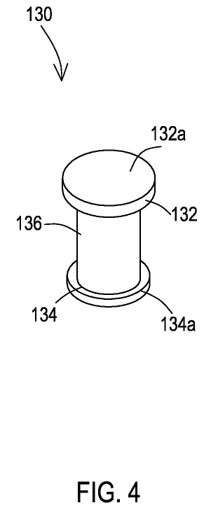

FIG. 4 illustrates a front view of a rivet 130, in accordance with one embodiment of the present invention. The rivet 130 can include a first end 132, a second end 134 and a generally cylindrical portion 136. The first end 132 can have a side protruding round top 132a coupled to the first end 132. The second end 134 can have a side protruding round bottom 134a coupled to the second end 134. The side protruding round top 132a and the side protruding round bottom 134a can secure the generally cylindrical portion 136 of the rivet 130 within the first aperture 114 and the second aperture 124 after the rivet 130 can be inserted into the first aperture 114 and the second aperture 124.

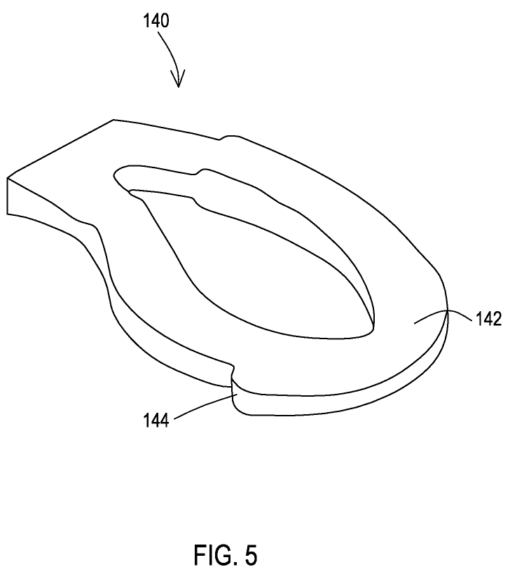

FIG. 5 illustrates an overhead view of an eye ring covering 140, in accordance with one embodiment of the present invention. The eye ring covering 140 can include a raised surfacing 142 and a second notch 144. The eye ring covering 140 can be placed on the first eye ring 112 and the second eye ring 122 to provide an ergonomic grip on the shell cracking device 100. The raised surfacing 142 can assist a user to grasp the first eye ring 112 and the second eye ring 122. The second notch 144 can ergonomically accommodate a user's fingers (not shown). The second notch 144 can also be disposed on the raised surfacing 142.

The shell cracking device is a relatively easy-to-use, relatively comfortable and ergonomic tool that integrates several different features in one device, all to make eating crab and lobster easier, safer, and overall more enjoyable. The shell cracking device looks similar to a pair of scissors. The shell cracking device has a pair of semi-circular cracking indentures located near the rivet and pivot point, and two sharp blade portions (one short and one long) to cut along the legs and body of a piece of crab or a piece of lobster, as well as to help retrieve meat within the piece of crab or the piece of lobster. The shell cracking device includes a pair of eye ring coverings that are symmetrical in size and shape to promote safe, steady, non-slip use even with a user's wet hands.

The shell cracking device can be utilized at home, while dining at a restaurant or at an all-you-can-eat seafood buffet. The shell cracking device can be a relatively handy, relatively indispensable tool and can be utilized by anyone who loves to eat fresh crab and lobster, but doesn't necessarily like all the difficult work and time-consuming steps it takes to access the meat contained within the shell. The shell cracking device can be a well-suited intuitive prep tool that can be utilized by chefs, Sous-chefs or anyone who has to quickly and efficiently prepare large amounts of seafood in a professional kitchen. The shell cracking device can be four tools in one. The shell cracking device can utilize the serrated oval-shaped eyelet cracker to break the crustacean claws without crushing the claw meat. The scissor portion bottom can be utilized to cut along the legs of a piece of lobster or a piece of crab, the scissor portion top of the shell cracking device can be utilized to cut along the body of a crab after lifting the gills of the crab, as well as to retrieve or pick-out the meat contained within the crab, which comes out undamaged and not crushed or mashed.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A shell cracking device, comprising:
a top scissor portion having a first eye ring, a first aperture, a first semi-circular cracking indenture and a first blade portion;
a bottom scissor portion coupled to the top scissor portion, the bottom scissor portion having a second eye ring, a second aperture, a second semi-circular cracking indenture and a second blade portion;
a rivet inserted into the first aperture and the second aperture, the rivet allows the top scissor portion and the bottom scissor portion to open and to receive a piece of shelled food and to close down on the piece of shelled food; and
an eye ring covering placed on the first eye ring and the second eye ring to provide an ergonomic grip on the shell cracking device.

2. The shell cracking device according to claim 1, wherein the first semi-circular cracking indenture is serrated.

3. The shell cracking device according to claim 1, wherein the top scissor portion is made of stainless steel.

4. The shell cracking device according to claim 1, wherein the second semi-circular cracking indenture is serrated.

5. The shell cracking device according to claim 1, wherein the bottom scissor portion is made of stainless steel.

6. The shell cracking device according to claim 1, wherein the piece of shelled food is a piece of shelled seafood.

7. The shell cracking device according to claim 1, wherein the eye ring covering is made of thermoplastic rubber.

8. A shell cracking device, comprising:
a top scissor portion having a first eye ring, a first aperture, a first serrated semi-circular cracking indenture and a first blade portion;
a bottom scissor portion coupled to the top scissor portion, the bottom scissor portion having a second eye ring, a second aperture, a second serrated semi-circular cracking indenture and a second blade portion;
a rivet inserted into the first aperture and the second aperture, the rivet allows the top scissor portion and the bottom scissor portion to open and to receive a piece of shelled food and to close down on the piece of shelled food, wherein the first semi-circular cracking indenture and the second semi-circular cracking indenture are disposed adjacent to the rivet; and
an eye ring covering placed on the first eye ring and the second eye ring to provide an ergonomic grip on the shell cracking device.

9. The shell cracking device according to claim 8, wherein the top scissor portion is made of stainless steel.

10. The shell cracking device according to claim 8, wherein the bottom scissor portion is made of stainless steel.

11. The shell cracking device according to claim 8, wherein the rivet is made of stainless steel.

12. The shell cracking device according to claim 8, wherein the piece of shelled food is a selected one of a piece of lobster and a piece of crab.

13. The shell cracking device according to claim 8, wherein the eye ring covering is made of thermoplastic rubber.

14. A shell cracking device, comprising:
a top scissor portion having a first eye ring, a first aperture, a first serrated semi-circular cracking indenture and a first blade portion;
a bottom scissor portion coupled to the top scissor portion, the bottom scissor portion having a second eye ring, a second aperture, a second serrated semi-circular cracking indenture and a second blade portion, wherein the top scissor portion is longer than the bottom scissor portion;
a rivet inserted into the first aperture and the second aperture, the rivet allows the top scissor portion and the bottom scissor portion to open and to receive a piece of shelled food and to close down on the piece of shelled food, wherein the rivet includes a first end, a second end and a generally cylindrical portion, wherein the first semi-circular cracking indenture and the second semi-circular cracking indenture are disposed adjacent to the rivet and wherein the piece of shelled food is a selected one of a piece of lobster and a piece of crab; and
an eye ring covering placed on the first eye ring and the second eye ring to provide an ergonomic grip on the shell cracking device, the eye ring covering includes a raised surfacing and a second notch.

15. The shell cracking device according to claim 14, wherein the top scissor portion is made of stainless steel.

16. The shell cracking device according to claim 14, wherein the bottom scissor portion is made of stainless steel.

17. The shell cracking device according to claim 14, wherein the first end has a side protruding round top coupled to the first end and the second end has a side protruding round bottom coupled to the second end, the side protruding round top and the side protruding round bottom secure the generally cylindrical portion of the rivet within the first aperture and the second aperture.

18. The shell cracking device according to claim 14, wherein the rivet is made of stainless steel.

19. The shell cracking device according to claim 14, wherein the eye ring covering is made of thermoplastic rubber.

20. The shell cracking device according to claim 14, wherein the eye ring covering is made of thermoplastic elastomer.
